(19) United States
(12) Patent Application Publication
(10) Pub. No.: US 2025/0215733 A1
(43) Pub. Date: Jul. 3, 2025

(54) Door mounted door position maintaining device

(71) Applicant: Sterling Scott, Anderson, SC (US)

(72) Inventor: Sterling Scott, Anderson, SC (US)

(21) Appl. No.: 18/402,727

(22) Filed: Jan. 3, 2024

(51) Int. Cl. E05C 17/44

(52) U.S. Cl. CPC E05C 17/446

(57) ABSTRACT

This invention is directed to a door mounted door position maintaining device with an adhesive strip for mounting on a door surface. The doorstop has a hollow body for containment of the operational parts, namely the shaft, which travels along a vertical axis and provides a way of stopping and holding the door or releasing the door from its held position. The handle used for activation or deactivation is located at one end of the shaft proximal to the top and the gripping friction foot is located at the furthest most point from the top or at the bottom. The foot uses friction when in contact with the floor to hold the door in place. A spring is utilized for additional stopping force in order to compensate for the lack of leverage due to the straight up and down orientation of the shaft. Weights may also be utilized.

### CROSS REFERENCE

Application No. 63/433,001
Filed: Dec. 15, 2022

### BACKGROUND OF INVENTION

Doorstops have long been used to hold doors in position. Oftentimes door hinges weaken, and jambs shift or sag as do building foundations. Homes and buildings often settle over time after being constructed resulting in the need for some form of device, mechanism, or object to keep doors from swinging open or closing on their own.

Prior art consists of floor or ground placed wedges, or weighted objects that must be placed or removed by bending down or using a foot to kick or manipulate placement of such stops. This can pose a problem for amputees, paraparaplegics, those with lower limb difference, persons utilizing wheelchairs or those with back issues inhibiting bending.

Other prior art must be placed within or around pinch points such ad hinge housings or tops and bottoms of doors. The placement and removal of such units can result in pinching or crushing of digits or phalanges. Floor positioned stops pose a trip and fall hazard. Other types of stops, such as wall mounted or recessed floor stops require doors to be held wide open with no allowance for partial open or closed positions.

Other prior art of the door mounted type require mounting hardware that leaves permanent holes in the door surface to which it is mounted. Such stops also require maintenance such as oiling to maintain ideal function of said stops. Such stops also lack aesthetic appeal due to their form of construction which is essential and fundamental to their function.

### SUMMARY OF INVENTION

The door mounted door position maintaining device quickly mounts and adheres to door surfaces without much effort or time. It virtually eliminates the pinching or crushing hazards of digits and phalanges associated with other certain types of stops during installation.

The door mounted door position maintaining device allows for the door to be positioned at any angle from fully closed to fully open. It is very low profile thusly eliminating the trip and fall hazard associated with many other common door stop types. It's sleek low profile appearance also helps lend to its aesthetic appeal. It's design allows for ease of use for lower limb amputees, paraplegics those with back pain problems or persons with lower limb difference. It also prevents easy access to operational parts to prevent chewing and ingestion of by domestic pets.

### BRIEF DESCRIPTION OF DRAWINGS

FIG. 1-15 Anterior view of device

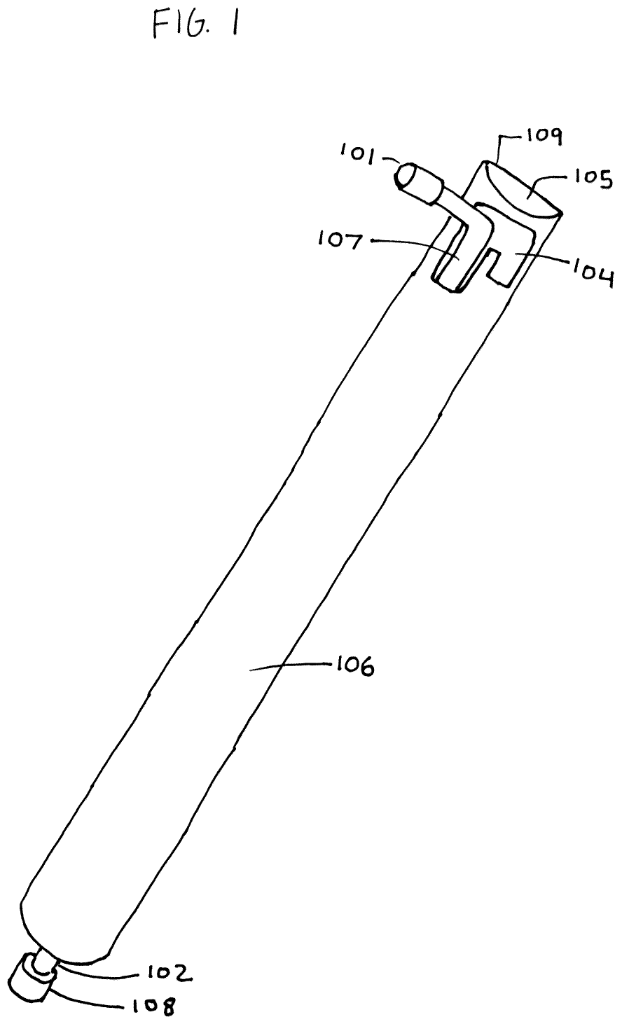

FIG. 2-15 Posterior view of device

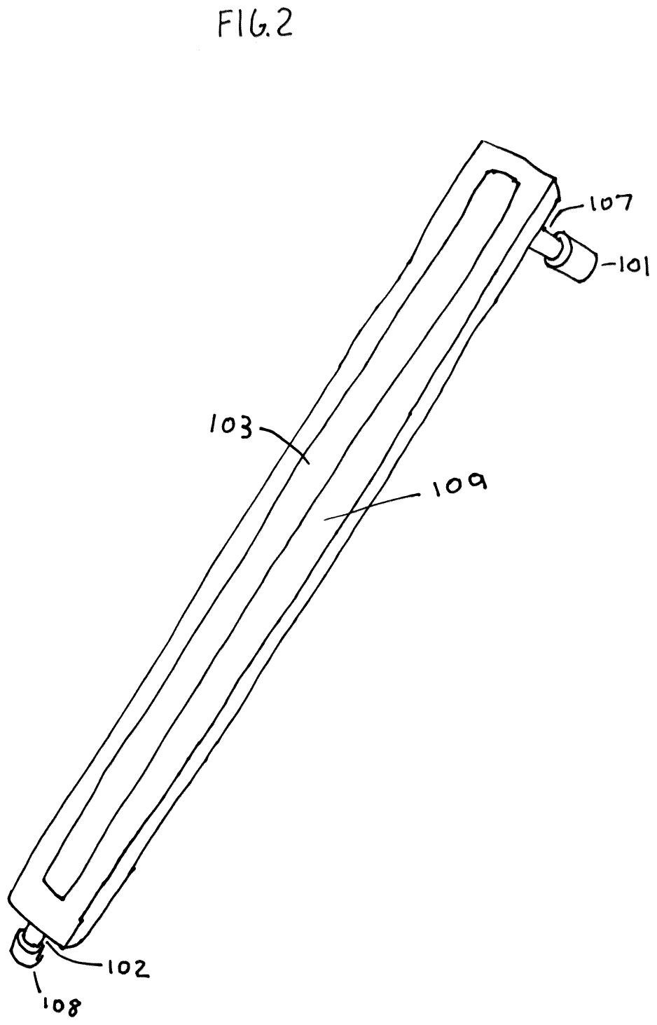

FIG. 3-15 Anterior view of body shell

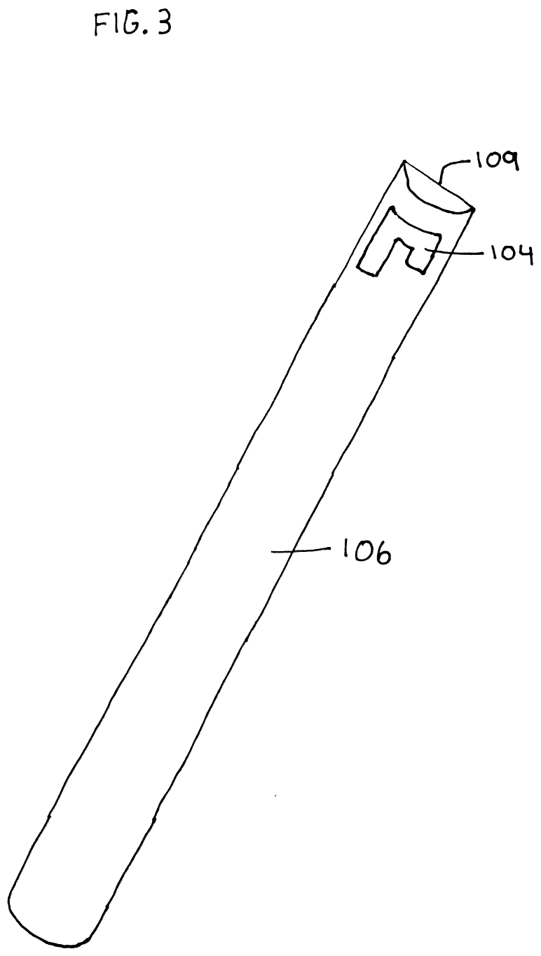

FIG. 4-15 Anterior view of device with unseen shaft depicted

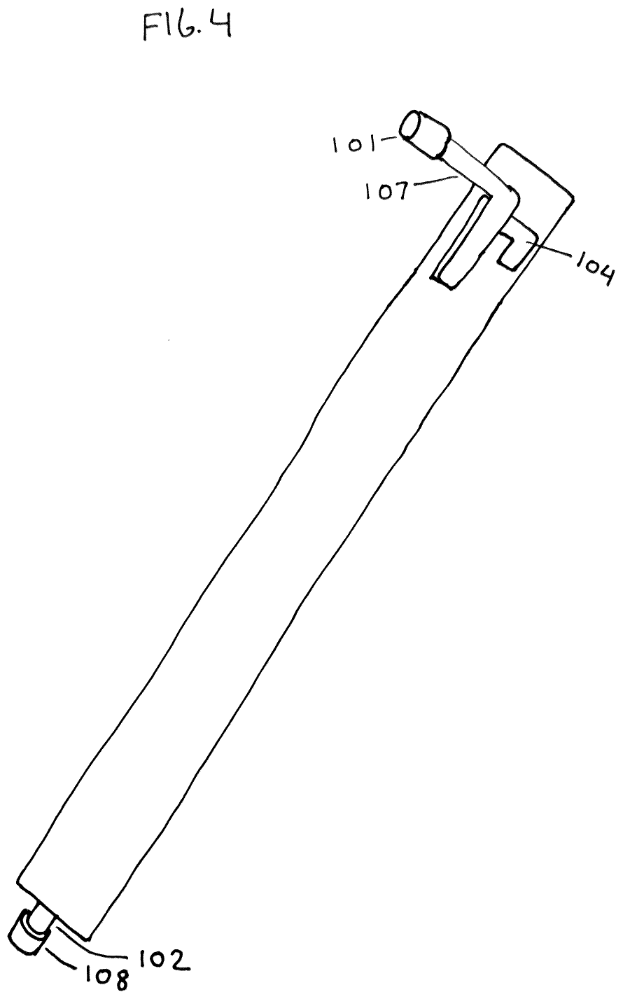

FIG. 5-15 Anterior view of internal rearward wall with shaft and brackets

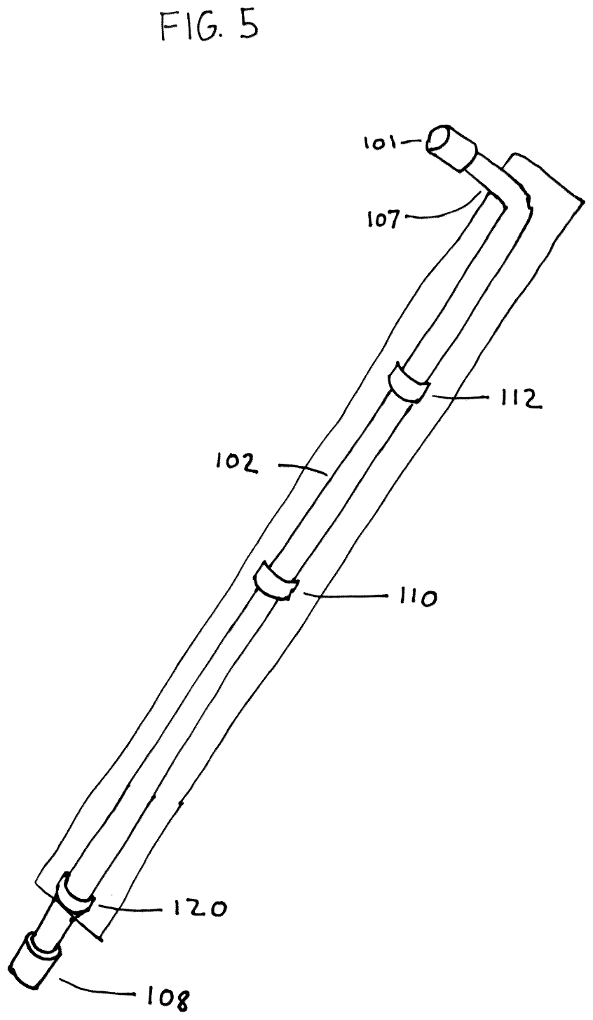

FIG. 6-15 Anterior view of internal rearward wall of iteration with spring

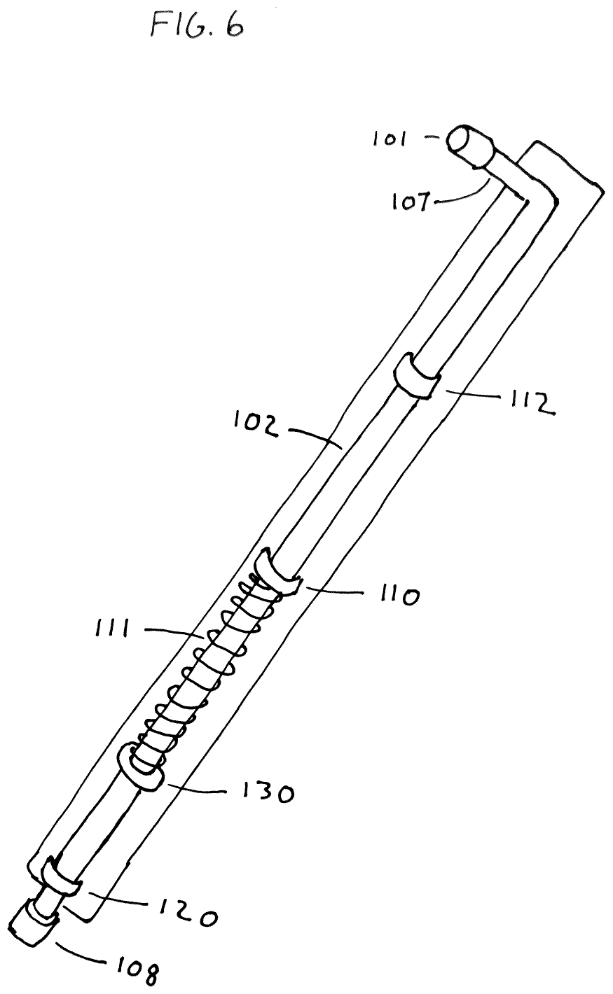

FIG. 7-15 Anterior view of internal rearward wall of iteration with ratcheting device

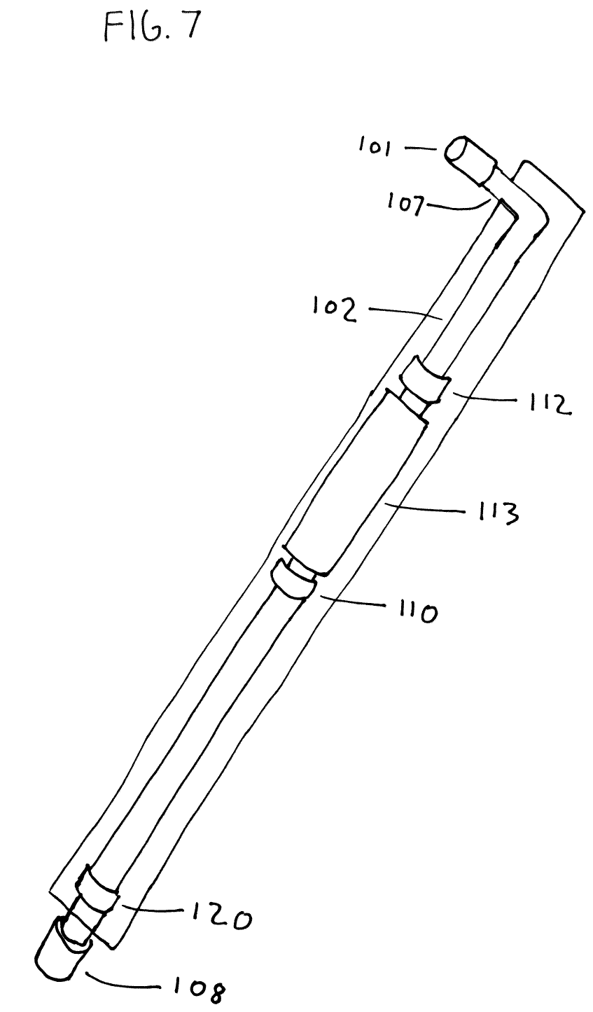

FIG. 8-15 Anterior view of internal rearward wall of iteration with ratcheting device and spring

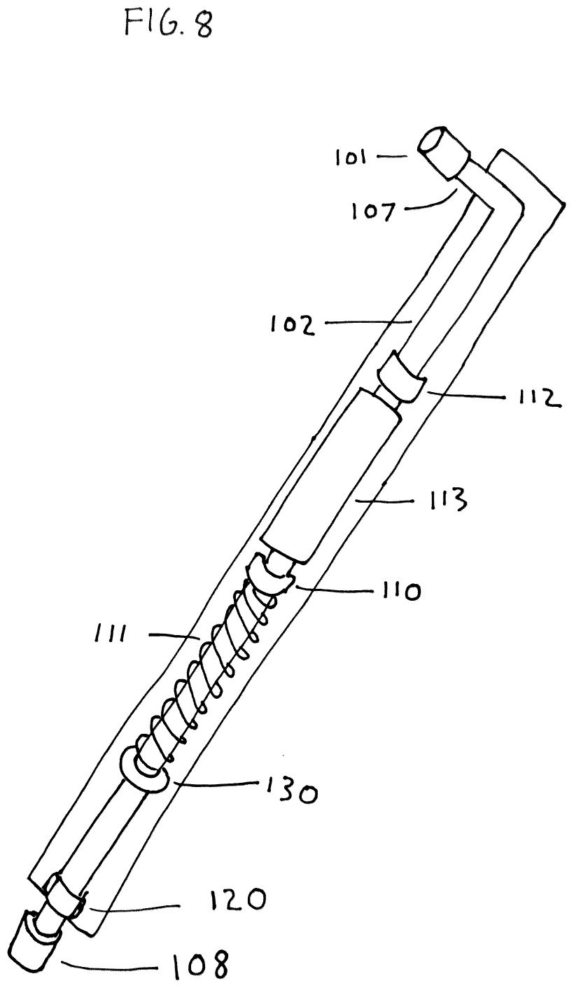

FIG. 9-15 Anterior view of device with unseen front wall depicted along with cap and track gate

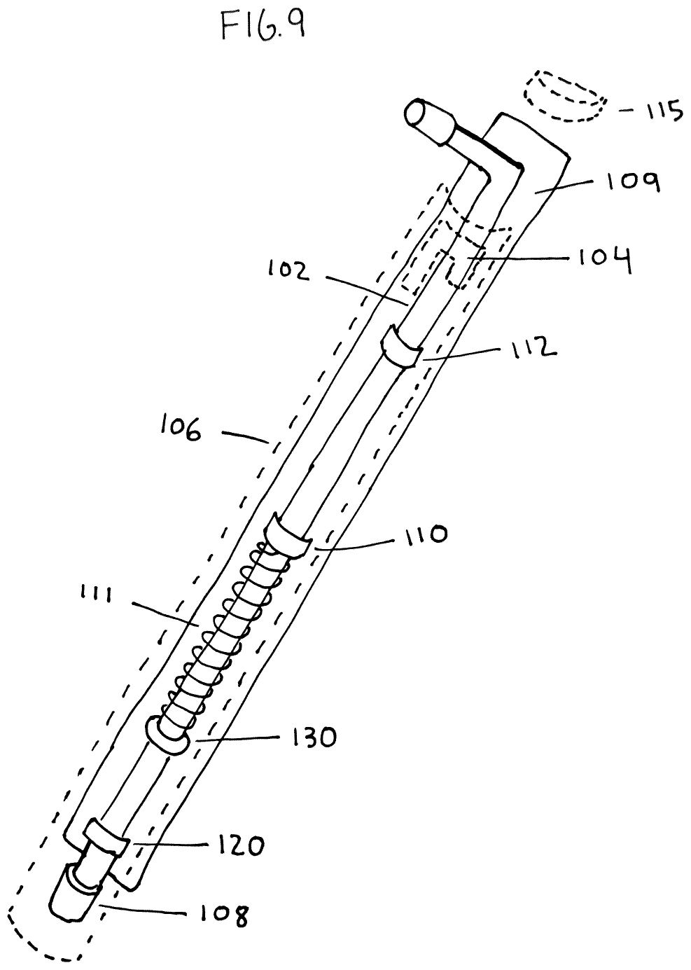

FIG. 10-15 Anterior view of device iteration with door knob grip depicting unseen shaft

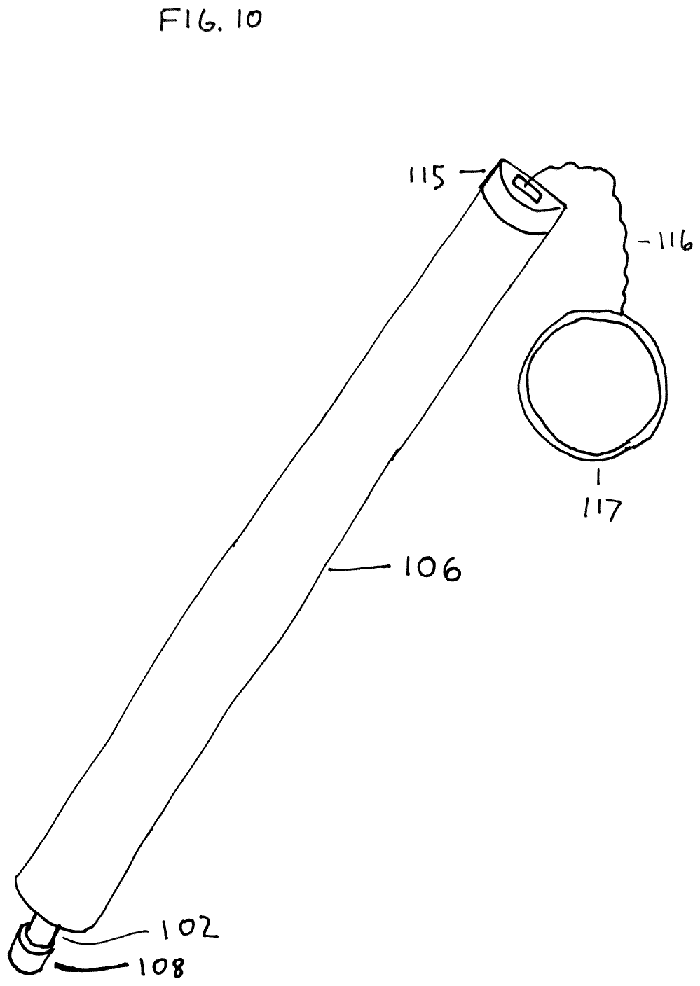

FIG. 11-15 Anterior view with door knob grip

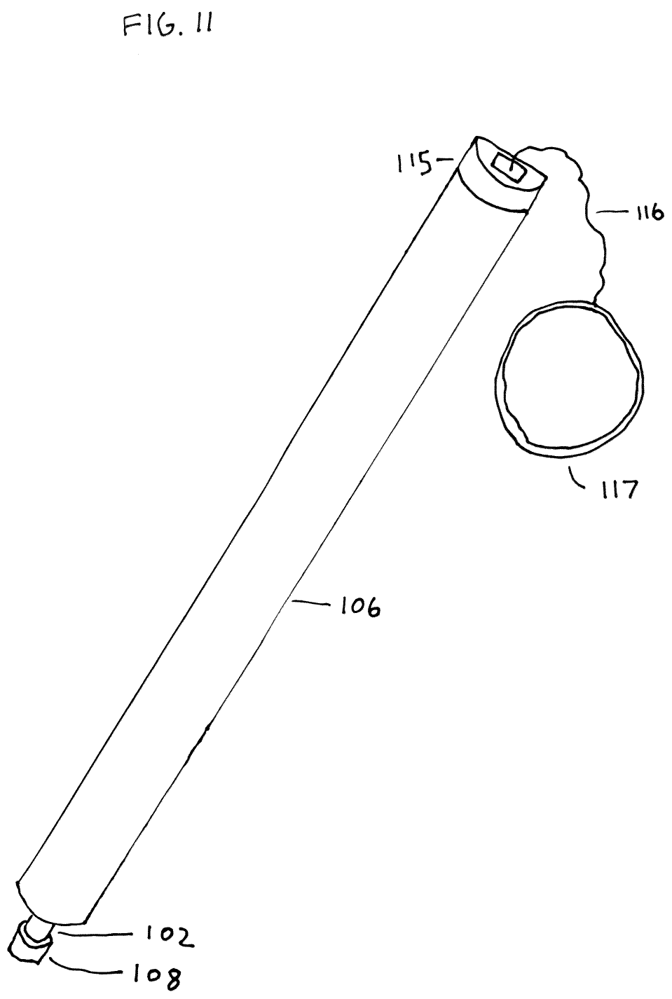

FIG. 12-15 Anterior view of internal rearward wall

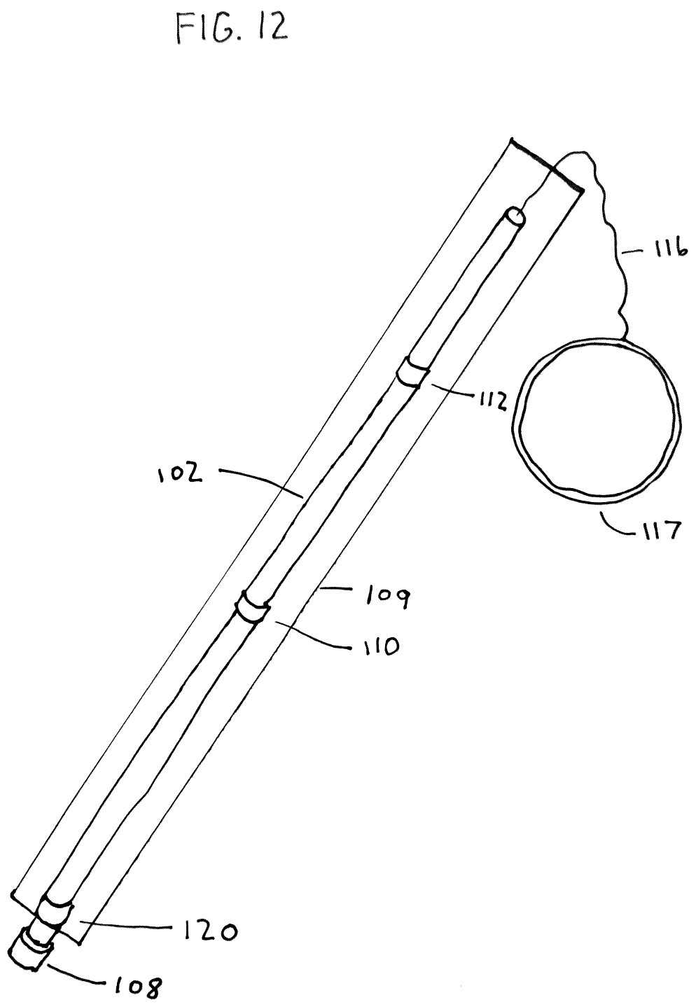

FIG. 13-15 Anterior view of internal rearward wall of iteration with spring

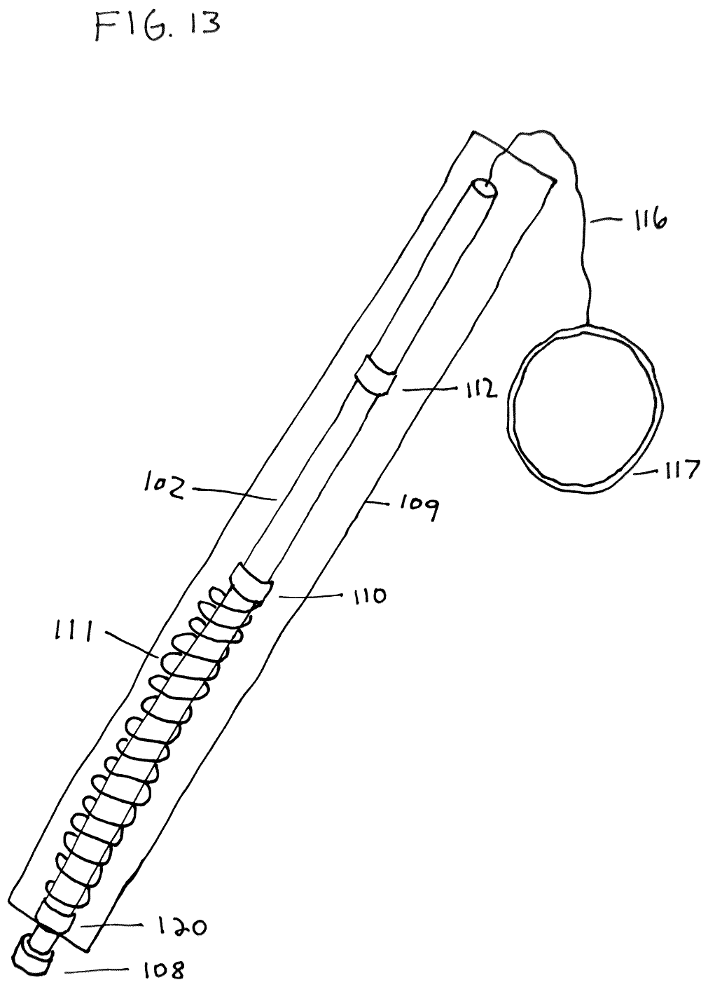

FIG. 14-15 Anterior view of internal rearward wall of iteration with ratcheting device

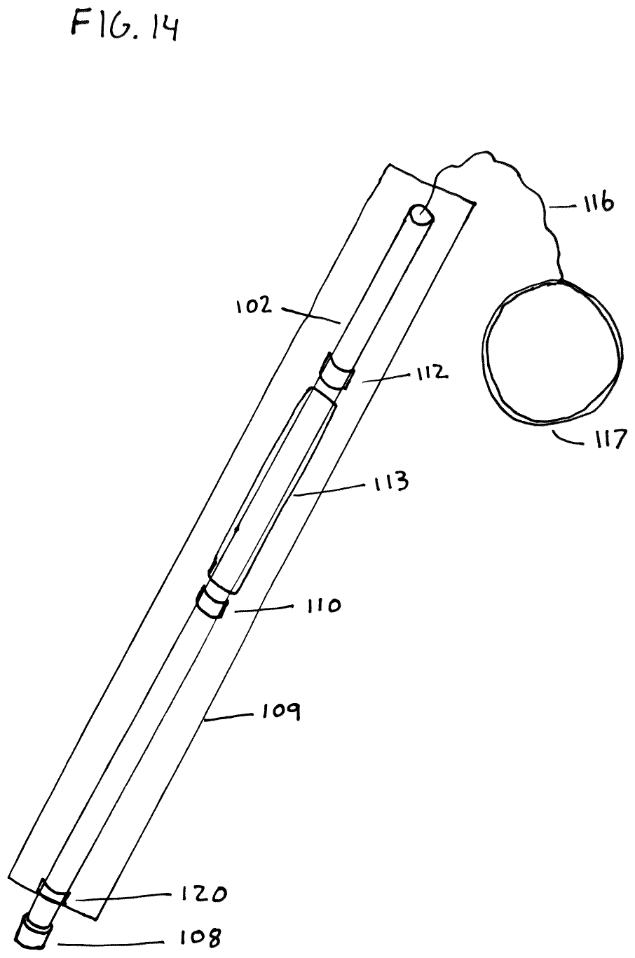

FIG. 15-15 Anterior view of internal rearward wall of iteration with a spring and ratcheting device

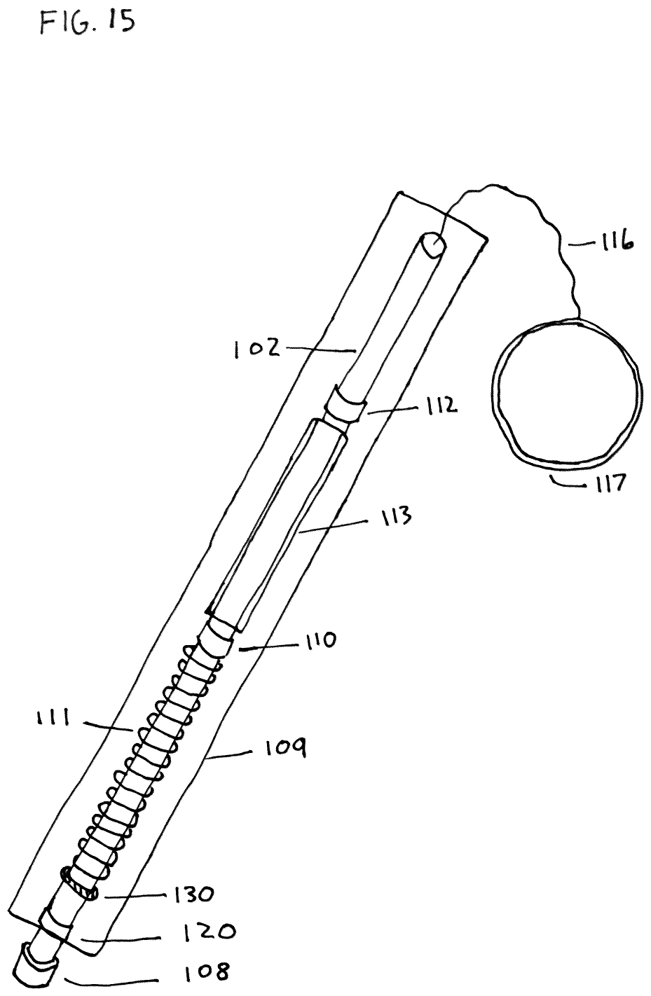

### DETAILED DESCRIPTION OF INVENTION

A door stopping device is provided for halting forward and reverse motion of a door or other sliding or swinging and hinged entryway blocking device. Said stopping device being capable of fully halting door movement via an adjustable extending appendage.

The door stopping device consisting of 106/109; a body. 103; a means of attachment to a door surface such as an adhesive strip or hook and loop type fastener. 102; an extending appendage with 108; a foot or tip for generating friction. Device also possessing 107; a handle in communication with 102 for activation and/or deactivation of the device. (One iteration of the device possessing 117; a mountable door knob grip in place of 107. Said iteration also possessing 116; a means of connection between the door knob grip and 102; the extending appendage.) 113; a position maintaining means for raising and lowering the extending appendage when engaged or disengaged and maintaining the extending appendage in set position. 111; a spring for provision of additional downward force other than gravity to provide position maintaining force upon the ground or floor. 111; the spring being held in place by 130; a ring-like stop for retention of the spring between itself and 110; the upper bracket. 130; the ring-like stop being solidly fixed onto 102; the extending appendage or shaft.

The door stopping device is described herein in its presently preferred embodiment and variations of said embodiment. However it should be noted that the invention in its full scope and parameters is in no way limited to the specific and particular parts components or configuration of such provided within this written description.

The door stopping device consisting of multiple parts. Namely: 106/109; a body. Said body being closed-end on at least one extremity by 115; an endcap. The body being preferably composed of durable lightweight and sturdy polymer or like material. In at least one iteration, said endcap possessing an aperture for passageway of 116; which is a means of connection between 117; the door knob grip and 102; the extending appendage or shaft. Said endcap being semicircular or half circle in formation with tabs or a rim equal to the internal diameter of 106/109, allowing for a press-fit into the hollow cavity of 106/109; the body. The body being composed of lightweight sturdy and durable material such as abs plastic, pvc or any such type polymer. Said body being elongated and measuring an average length of approximately 33 inches, slightly shorter than the average door handle or knob height.

The body being half circular or 180 degree arched. In alternative iterations the body also possibly being square or rectangular or triangular in shape. The body being capable of housing and containing the necessary parts for animation and operation of the device, including components 102, 110, 120, 130, 111, 112, 113. The body also consisting of two primary parts, 106; a front wall and 109; a rear wall. 109; the rearward wall possessing on its exterior surface part 103; an adhesive strip for mounting onto a door surface. The front wall, 106, also possessing one semicircular half of the brackets 110, 112 and 120; the duo or possibly plurality of brackets for guidance and retention of 102; the extending appendage or shaft. When 106 and 109 are mated together, the semicircular halves contained within each wall come together and form the fully circular brackets 110, 112, and 120 which are able to contain and guide 102.

106 also possessing, 104; a gated groove for guidance and retention of 107; the handle for activation and deactivation of the device. 107 also possessing, 101; a grip for grasping, possibly being coated or imbued with phosphorescent material to facilitate ease of location in dark rooms and low light situations. 107 being in direct conjunction and communication with 102; the shaft or extending appendage.

102; a shaft or extending appendage possesses range of motion along a vertical axis within the mated parts of 106/109; the hollow body. Said appendage extending significantly beyond the lowest point of the body when the appendage is extended. The appendage being capable of retraction partially into the body and possessing 108; a tip coated with or composed of a high friction non marking material such as rubber. Said tip allowing for maximum gripping of the floor or ground surface.

117; a door handle/knob grip designed to fit and stay affixed to door knobs via the interaction of forces of friction exerted between the interior surface of the grip and the external surface of the door handle or knob. Said grip being composed of high friction, preferably antimicrobial materials. Said grip being attached to the extending appendage via 116; a means of continuous connection and communication to 102; the extending appendage, thereby facilitating and controlling its extension and retraction.

106/109; the hollow body also possessing 103; A means of attachment to a door surface such as an adhesive strip or hook and loop strip. Said means of attachment being affixed to the back of the body and being capable of strong and sturdy adhesion and resistant to vibration and shock and like stresses.

116; a means of connection and constant communication between 117; the door handle/knob grip and 102; the extending appendage such as a chord or wire or suchlike tether. Said means of connection being composed of metal or high tensile strength fabric or polymer or chord and being a single strand or consisting of a plurality of such strands intertwined or braided.

One iteration of the invention also possessing 113; A ratcheting or rotating and holding type mechanism, similar to that of a retractable click pen, utilizing spring(s) a roller and/or cam to both retract and retain retraction or extend and retain extension of 102; the extending appendage. 110, 112, and 120; a series of brackets for retention of 113 and guidance of 102 thereby allowing the extending appendage to raise and lower according to a predetermined path.

Mode of operation is as follows: The user adjust the body mounting height as needed to provide necessary clearance between the body and floor and extending appendage foot. The user attaches the body of the device to the door using the adhesive strip or hook and loop fastener strip. The user then connects 117; the door handle/knob grip to the door knob by stretching it over the door knob where it is held in position by friction. At this point the unit is mounted and ready for usage. Mounting of the iteration with 107; the handle, is the same with the exception of connection of 117, as there is no door handle/knob grip with the iteration possessing 107; the handle.

To initiate usage the user grasps the door knob grip and twists. As the grip twists the means of connection between the grip and extending appendage is pulled taut thereby engaging and lifting the extending appendage either directly or via engagement of the ratchet/click type mechanism. When the extending appendage is lifted the device is disengaged and the door is free to move. When the device is engaged then the extending appendage is down and in contact with the floor thereby limiting or halting door movement. The device can also be activated by turning an opposing door handle or knob on the other side of the door, which does not house the invention's door handle/knob grip but which is connected to the door handle or knob housing the invention's handle/knob grip.

In one variant iteration the door stop can also be activated via its own handle moving within a groove which guides and maintains the position of the extending appendage. The manner of mounting remains the same. In this variation activation and deactivation is achieved by lifting and sliding the units handle from either the disengaged or engaged position within 104; the gated track. It is then held in its designated position by gravity or the ratchet/click type mechanism or through tension of a spring providing force for holding power and increase of friction.

What is claimed is:

1. A door mounted door stopping device for halting motion of a swinging or sliding door, comprising a door knob grip; an extending and retractable appendage; a position maintaining mechanism for position regulation of the extending appendage; a flexible and durable means of connection between the door knob grip and extending appendage or position maintaining mechanism; a hollow or semi hollow body possessing brackets and walls for housing of all necessary components; a high friction non-marking tip at the bottom most extremity of the extending appendage, being actuated via the knob or via the device's own handle.

2. The door stopping device of claim 1 further comprising a flexible door knob grip.

3. The door knob grip of claim 2 being composed of rubber or similar flexible material preferably possessing antimicrobial properties and high friction gripping qualities.

4. The door knob grip of claim 3 being specifically shaped in construction to accommodate a door knob or door handle tightly within its inner walls while facilitating grasping by hands along its outer wall(s) or surface(s).

5. The door stopping device of claim 1 further comprising an extending appendage being rod like and cylindrical or squared and in one iteration possessing a handle for activation and deactivation.

6. The door stopping device of claim 5 possessing a means of connection between the door knob grip and the extending appendage such as a chord or wire or suchlike tether.

7. The extending appendage of claim 5 further comprising a position maintaining mechanism similar to such like mechanism found in a mechanical retractable click pen or being of a groove type guide allowing for the extending appendage to move in a series of sequential steps along a predetermined path and being in communication with the extending appendage for lifting and holding the raised position or lowering and maintaining lowered position of the extending appendage.

8. The extending appendage of claim 7 wherein the bottom most extremity possesses a length adjustable high friction tip.

9. The door stopping device of claim 1 further comprising a semi circular body with one flat rearward wall and a curved or arched forward wall, or two flat forward angled walls comprising a triangular composition, or one forward wall and two side walls compromising a square like composition, with all iterations possessing a singular flat rearward wall.

10. The semi circular or triangular or square body of claim 9 being hollow, possessing a semicircular half of the retaining brackets on each wall and wherein the rearward wall of the body possesses an adhesive or hook and loop type strip on its exterior for attachment to a door surface.

11. The door stopping device of claim 9 being no more than thirty eight (38) inches in length and no less than seven (7) inches in length.

12. The extending appendage of claim 8 possessing a spring for compression.

13. The extending appendage of claim 12 possessing a ring-like bracket attachment for compression of the spring between said bracket attachment and the bracket formed within the hollow body.
